(19) United States
(12) Patent Application Publication
(10) Pub. No.: US 2009/0235788 A1
(43) Pub. Date: Sep. 24, 2009

(54) HAND TOOL FOR PROVIDING HIGH TWISTING FORCES AND LOW DAMAGE TO SCREW

(76) Inventor: Chih-Ching HSIEH, Taichung County (TW)

Correspondence Address: Chien-Hui Su, P. O. Box 70-121 Taichung, Taichung City, 40899, TW

(21) Appl. No.: 12/479,862

(22) Filed: Jun. 8, 2009

Related U.S. Application Data
(63) Continuation-in-part of application No. 11/036,704, filed on Jan. 18, 2005.

(51) Int. Cl. B25B 13/06

(52) U.S. Cl. 81/121.1

(57) ABSTRACT

A hand tool for providing high twisting forces and low damage to a screw includes a handle having a driving end. The driving end has an inner hexagonal space. The driving end has three engaging portions and three flat portions respectively form in six edges of the inner hexagonal space. The three engaging portions and the three flat portions are alternatively disposed. The driving end has six recesses. Each recess is disposed between the engaging portion and the flat portion adjacent to the engaging portion. Each engaging portion has two cambered protrusions and a sharp protrusion disposed between the two cambered protrusions. An apex of the sharp protrusion and those of the two cambered protrusions are collinear.

### CROSS-REFERENCE TO RELATED APPLICATION

This application is a Continuation-in-part Application of Ser. No. 11/036,704, filed Jan. 18, 2005, and entitled “CLAMPING DEVICE FOR PROVIDING HIGH TWISTING FORCES AND LOW DAMAGE TO SCREW DEVICE”, now pending.

### BACKGROUND OF THE INVENTION

1. Field of the Invention

The present invention relates to a hand tool, and more particularly to a hand tool for providing high twisting forces and low damage to a screw.

2. Description of Related Art

There are many improvements for improving the twisting force of a sleeve or a spanner. A conventional sleeve comprises a polygonal space defined therein. Each side of the polygonal space is teethed to increase the friction force between the sleeve and the screw received in the polygonal space. When a great twisting force is applied, the teeth are damaged at the apexes such that the friction force is reduced. The teeth also damage the screw. After a period of usage, the sleeve and the screw are broken. The conventional spanner with the teeth has the same problem.

The present invention has arisen to mitigate and/or obviate the disadvantages of the conventional hand tool.

### SUMMARY OF THE INVENTION

The main objective of the present invention is to provide an improved hand tool for providing high twisting forces and low damage to a screw.

To achieve the objective, the hand tool for providing high twisting forces and low damage to a screw includes a handle having a driving end formed in one end thereof. The driving end has an inner hexagonal space defined therein. The driving end has three engaging portions and three flat portions respectively form in six edges of the inner hexagonal space. The three engaging portions and the three flat portions are alternatively disposed. The driving end has six recesses formed therein. Each recess is disposed between each engaging portion and the flat portion adjacent to the engaging portion for receiving an apex of the screw. Each engaging portion has two cambered protrusions respectively extend from two ends thereof and a sharp protrusion extended therefrom and disposed between the two cambered protrusions. An apex of the sharp protrusion and those of the two cambered protrusions are collinear.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hand tool for providing high twisting forces and low damage to a screw in accordance with the present invention;

FIG. 2 is a top plane view of the hand tool for providing high twisting forces and low damage to a screw in accordance with the present invention, showing the driving end;

FIG. 3 is a top plane view of the hand tool for providing high twisting forces and low damage to a screw in accordance with the present invention, showing the screw received in the inner hexagonal space; and

FIG. 4 is a perspective view of a second embodiment of a hand tool for providing high twisting forces and low damage to a screw in accordance with the present invention.

### DETAILED DESCRIPTION OF THE INVENTION

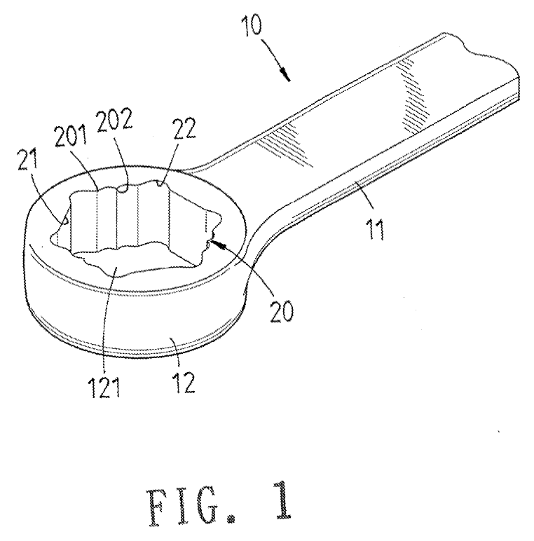

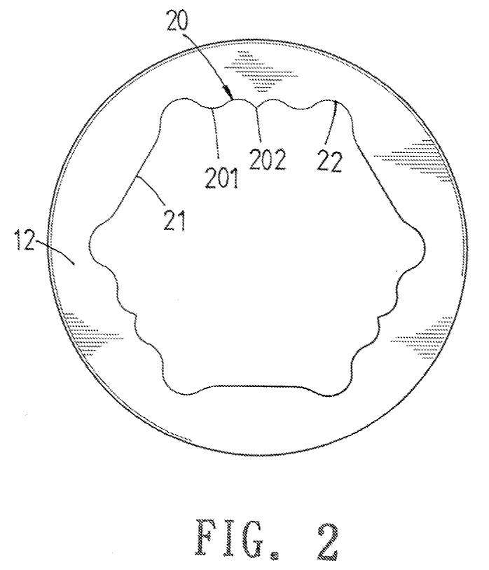

Referring to the drawings and initially to FIGS. 1-3, a hand tool for providing high twisting forces and low damage to a screw in accordance with the present invention is illustrated. In the preferred embodiment the hand tool is a spanner 10. The hand tool for providing high twisting forces and low damage to a screw in accordance with the present invention comprises a handle 11 having a driving end 12 formed in one end thereof. The driving end 12 has an inner hexagonal space 121 defined therein for receiving a screw 30. The driving end 12 has three engaging portions 20 and three flat portions 21 respectively formed in six edges of the inner hexagonal space 121. The three engaging portions 20 and the three flat portions 21 are alternatively arranged. The driving end 12 has six recesses 22 formed therein, each recess 22 disposed between the engaging portion 20 and the flat portion 21 for receiving an apex 31 of the screw 30 to prevent the screw 30 from damage.

Each engaging portion 20 has two cambered protrusions 201 extended therefrom and respectively disposed in two ends thereof. Each engaging portion 20 has a sharp protrusion 202 extended therefrom and disposed between the two cambered protrusions 201. An apex of the sharp protrusion 202 and those of the two cambered protrusions 201 are collinear.

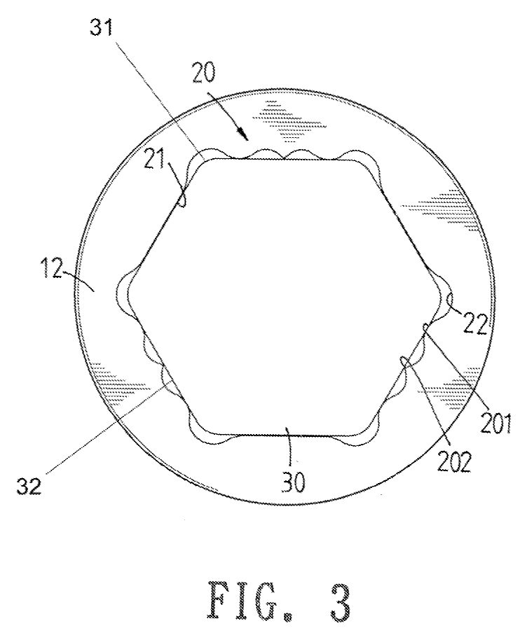

Referring to FIG. 3, the hexagonal screw 30 is received in the inner hexagonal space 121. Each flat portion 21 abuts against a flat surface 32 of the screw 30 for providing more contacting surface. The two cambered protrusions 201 and the sharp protrusion 202 of each engaging portion 20 abuts against the other one flat surface 32 of the screw 30 for increasing a twisting force from the spanner 10 to the screw 30. Each apex 31 of the screw 30 is received in the recess 22 such that the apex 31 will not wear. The flat portion 21, the cambered protrusion 201, and the sharp protrusion 202 increase the friction force such that the screw 30 is driven easily.

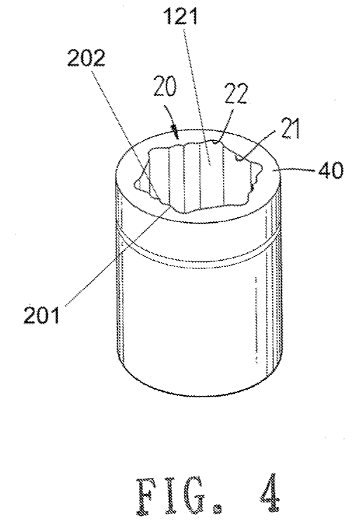

Referring to FIG. 4, a second embodiment of the hand tool for providing high twisting forces and low damage to a screw in accordance with the present invention is illustrated. In the second embodiment, the hand tool is a sleeve 40. The hand tool for providing high twisting forces and low damage to a screw in accordance with the present invention comprising a sleeve 40 having an inner hexagonal space 121 defined therein. The sleeve 40 has three engaging portions 20 and three flat portions 21 respectively formed in six edges of the inner hexagonal space 121. The three engaging portions 20 and the three flat portions 21 are alternatively arranged. The sleeve 40 has six recesses 22 formed therein, each recess 22 disposed between the engaging portion 20 and the flat portion 21.

Each engaging portion 20 has two cambered protrusions 201 extended therefrom and respectively disposed in two ends thereof. Each engaging portion 20 has a sharp protrusion 202 extended therefrom and disposed between the two cambered protrusions 201. A apex of the sharp protrusion 202 and those of the two cambered protrusions 201 are collinear.

Although the invention has been explained in relation to its preferred embodiment, it is to be understood that many other possible modifications and variations can be made without departing from the spirit and scope of the invention as hereinafter claimed.

What is claimed is:

1. A hand tool for providing high twisting forces and low damage to a screw comprising:
a handle having a driving end formed in one end thereof, the driving end having an inner hexagonal space defined therein, the driving end having three engaging portions and three flat portions respectively form in six edges of the inner hexagonal space, the three engaging portions and the three flat portions alternatively disposed, the driving end having six recesses formed therein, each recess disposed between each engaging portion and the flat portion adjacent to the engaging portion for receiving an apex of the screw, each engaging portion having two cambered protrusions respectively extend from two ends thereof and a sharp protrusion extended therefrom and disposed between the two cambered protrusions;
wherein an apex of the sharp protrusion and those of the two cambered protrusions are collinear.

2. A hand tool for providing high twisting forces and low damage to a screw comprising:
a sleeve having an inner hexagonal space defined therein, the sleeve having three engaging portions and three flat portions respectively form in six edges of the inner hexagonal space, the three engaging portions and the three flat portions alternatively disposed, the sleeve having six recesses formed therein, each recess disposed between each engaging portion and the flat portion adjacent to the engaging portion for receiving an apex of the screw, each engaging portion having two cambered protrusions respectively extend from two ends thereof and a sharp protrusion extended therefrom and disposed between the two cambered protrusions;
wherein an apex of the sharp protrusion and those of the two cambered protrusions are collinear.
